(19) United States
(12) Patent Application Publication
(10) Pub. No.: US 2024/0393986 A1
(43) Pub. Date: Nov. 28, 2024

(54) INFORMATION PROCESSING APPARATUS, PRINT SETTING METHOD, AND RECORDING MEDIUM HAVING APPLICATION RECORDED THEREON

(71) Applicant: SHARP KABUSHIKI KAISHA, Sakai City, Osaka (JP)

(72) Inventor: SHINICHI KAWANO, Sakai City (JP)

(21) Appl. No.: 18/608,414

(22) Filed: Mar. 18, 2024

(30) Foreign Application Priority Data
May 22, 2023 (JP) 2023-084027

(51) Int. Cl. G06F 3/12

(52) U.S. Cl. CPC G06F 3/1205; G06F 3/1238; G06F 3/1255; G06F 3/1257; G06F 3/1285

(57) ABSTRACT

An information processing apparatus including a storage which stores an application capable of supporting a print setting corresponding to a device in cooperation with a printer driver and a controller which obtains device information of the device associated with the application when the application is activated, in which the controller stores the print setting corresponding to the device in the storage on the basis of the obtained device information and reflects the print setting stored in the storage at print execution on the basis of the application.

### BACKGROUND OF THE INVENTION

### Field of the Invention

The present disclosure relates to an information processing apparatus and the like.

### Description of the Background Art

A printer driver supplied by a vendor that provides a printing apparatus is configured to maximize the performance of the printing apparatus. However, the printer driver supplied by the vendor needs to be individually introduced by a user who uses the printing apparatus. Therefore, for a user who has difficulty in obtaining a printer driver because a network environment or the like is not prepared, for example, it is difficult to introduce a printer driver supplied by a vendor.

On the other hand, though a standard printer driver (hereinafter, simply referred to as a printer driver) incorporated in an operating system (OS) in advance does not need to be individually introduced by a user who uses a printing apparatus, available functions are limited to standard functions in order to cope with various types of printing apparatuses.

In view of such circumstances, in recent years, efforts have been made to fully utilize the capabilities of a printing apparatus by introducing a print support application (PSA) that supports printing using a printer driver.

An object of the present disclosure is to provide an information processing apparatus and the like capable of reflecting print settings corresponding to individual printing apparatuses in print processing using PSA.

### SUMMARY OF THE INVENTION

In order to solve the aforementioned problem, an information processing apparatus according to this disclosure includes a storage that stores an application capable of supporting a print setting corresponding to a device in cooperation with a printer driver and a controller that obtains device information of the device associated with the application when the application is activated, characterized in that the controller stores the print setting according to the device in the storage on the basis of the obtained device information and at print execution on the basis of the application, the print setting stored in the storage is reflected.

Moreover, a print setting method according to the present disclosure is characterized in that an application that cooperates with a printer driver and can support a print setting corresponding to a device is stored in a storage device, and when the application is activated, device information of the device associated with the application is obtained, the print setting corresponding to the device is stored in the storage device on the basis of the obtained device information, and the print setting stored in the storage device is reflected at print execution on the basis of the application.

Moreover, an application according to the present disclosure is an application which cooperates with a printer driver and can support a print setting corresponding to a device, obtains device information of the associated device when activated, stores the print setting corresponding to the device in a storage device on the basis of the obtained device information, and reflects the print setting stored in the storage device upon receipt of a print execution instruction, and the application is recorded in a non-transitory computer-readable recording medium.

According to the present disclosure, it is possible to provide an information processing apparatus and the like capable of reflecting print settings corresponding to individual printing apparatuses in print processing using PSA.

### BRIEF DESCRIPTION OF THE DRAWINGS

FIG. 1 is a diagram for explaining a connection form of an information processing apparatus according to a First Embodiment.

FIG. 2 is a diagram for explaining a functional configuration of the information processing apparatus according to the First Embodiment.

FIG. 3 is a diagram for explaining an example of data configuration of Device Containers.

FIG. 4 is a diagram for explaining a functional configuration of a printing apparatus according to the First Embodiment.

FIG. 5 is a sequence diagram for explaining print processing using a printer driver and PSA.

FIG. 6 is a flowchart for explaining a flow of processing according to the First Embodiment.

FIG. 7 is a diagram for explaining an example of a data configuration of a device management table.

FIG. 8 is a flowchart for explaining a flow of processing process according to the first embodiment.

FIGS. 9A and 9B are diagrams for explaining an operation example according to the First Embodiment.

FIG. 10 is a diagram for explaining an operation example according to the First Embodiment.

FIGS. 11A and 11B are diagrams for explaining an operation example according to the First Embodiment.

FIG. 12 is a diagram for explaining an operation example according to the First Embodiment.

FIG. 13 is a diagram for explaining an operation example according to the First Embodiment.

FIG. 14 is a diagram for explaining an operation example according to the First Embodiment.

FIG. 15 is a diagram for explaining an operation example according to the First Embodiment.

FIG. 16 is a diagram for explaining a functional configuration of the information processing apparatus according to a Second Embodiment.

FIG. 17 is a flowchart for explaining a flow of processing according to the Second Embodiment.

FIG. 18 is a diagram for explaining a functional configuration of the information processing apparatus according to a Third Embodiment.

FIG. 19 is a flowchart for explaining a flow of processing according to the Third Embodiment.

### DESCRIPTION OF THE PREFERRED EMBODIMENTS

Hereinafter, embodiments of the present disclosure will be explained with reference to the drawings. Note that the following embodiments are examples for explaining the present disclosure, and technical contents of the explanation described in the scope of claims are not limited to the following description.

When a printing apparatus such as a multifunction peripheral is controlled to cause a print job to be processed, an information processing apparatus generates a print job via a dedicated printer driver installed in an operating system (OS) or a printer driver provided as a standard function of the OS. In general, a dedicated printer driver to be used by being installed in the OS is provided for each printing apparatus by a vendor of the printing apparatus, and is configured to be able to sufficiently exert capability of the printing apparatus.

On the other hand, the printer driver only supports functions common to the respective printing apparatuses in order to provide versatility that enables printing by many (many types of) printing apparatuses in many cases. In recent years, even in the case of processing a print job using a printer driver, there has been an increasing demand for the print results similar to those in the case of using a dedicated printer driver. Further, in order to improve stability and security of the OS, approaches have been made by vendors that provide the OS to expand the functions of the printer driver.

As one of forms of the aforementioned approaches, PSA that supports processing of a print job by a printer driver is known. In general, the PSA is supplied as an application by a vendor or the like that provides an OS or a printing apparatus. The PSA is configured to cooperate with the printer driver so that the functions of the printing apparatus can be sufficiently exerted on the basis of the obtained capability information of the printing apparatus. For example, the PSA can change Page Description Language (PDL) and give a Print Job Language (PJL) command to a print job based on the printer driver.

As a communication protocol for transmitting and receiving a print job and necessary information between an information processing apparatus and a printing apparatus, Internet Printing Protocol (IPP) is known. In IPP, a print job is expressed by document data in a predetermined PDL format and IPP attribute information. Here, the IPP attribute information includes attributes and values thereof (attribute values) that define print settings of the printing apparatus, device settings, output capabilities (number of printable copies, finisher forms, print quality and the like, for example) of the printing apparatus, in addition to definitions related to printer operations such as “Print-Job (print execution)”, “Get-Printer-Attributes (Printer attribute obtainment)” and the like and definitions related to job operations such as “Get-Job-Printer-Attributes (Job status obtainment)”, “Cancel-Job (Job cancellation)” and the like. The PSA obtains the capability information of the printing apparatus by communicating with the printing apparatus via a network on the basis of the IPP, and the printing apparatus can process the print job by analyzing the attribute value defined in the IPP attribute information.

When the PSA is associated with a printing apparatus on a network in compliant with the IPP, the PSA can display a user interface (UI) suitable for the printing apparatus and accept print settings.

However, when the PSA installed on the OS was singularly activated, it was not possible to grasp at a glance which printing apparatus is associated with the PSA. Therefore, there has been no choice but to apply common print settings to the associated printing apparatus.

An information processing apparatus capable of reflecting a print setting corresponding to each printing apparatus in print processing using the PSA is realized in the following embodiments.

### 1 First Embodiment

### 1. 1 Overall Configuration

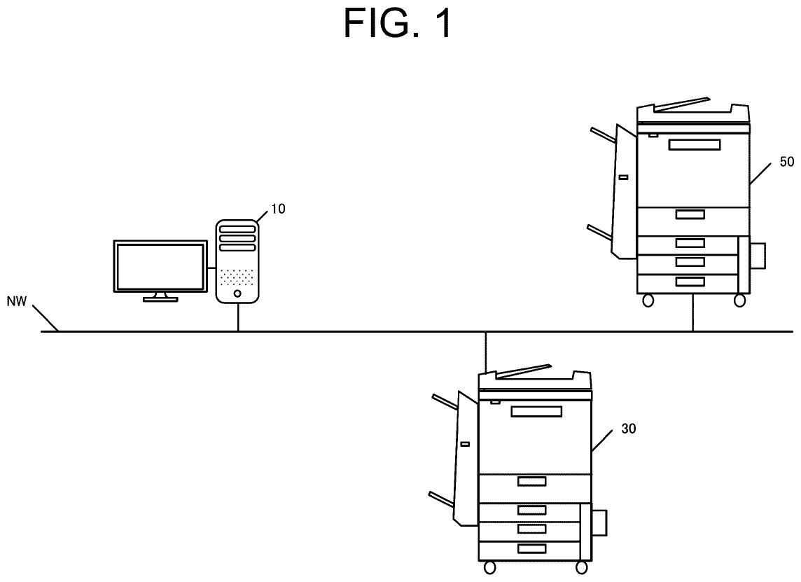

FIG. 1 is a view for explaining an example of a connection form between a terminal device 10 as an information processing apparatus according to the First Embodiment, a multifunction peripheral 30 as a printing apparatus, and a multifunction peripheral 50 also as the printing apparatus.

The terminal device 10 according to the First Embodiment can be configured as a computer capable of operating on the basis of a specific OS. The terminal device 10 can generate a print job on the basis of a printer driver incorporated in the OS in advance and transmit it to the multifunction peripheral 30 or the multifunction peripheral 50 via a network NW. The multifunction peripheral 30 or the multifunction peripheral 50 is a printing apparatus capable of realizing jobs such as printing, copying, faxing, image transmission and the like in a single housing. The multifunction peripheral 30 or the multifunction peripheral 50 can form an image based on the print job received from the terminal device 10 on a recording sheet.

By the way, FIG. 1 shows a form in which each of the printing apparatuses of the multifunction peripheral 30 and the multifunction peripheral 50 is connected to the network NW one by one, but the multifunction peripheral 30 and the multifunction peripheral 50 may be connected to another network NW, not shown, connected to the network NW, and a plurality of multifunction peripherals 30 and multi peripherals 50 may be connected to the network NW. Further, the multifunction peripheral 30 or the multifunction peripheral 50 may be a printing apparatus specialized for a specific function such as a printer or a facsimile apparatus. Note that, when the multifunction peripheral 30 and the multifunction peripheral 50 do not have to be distinguished, they shall be simply referred to as the multifunction peripheral 30 or the like.

### 1. 2 Functional Configuration

### 1. 2. 1 Terminal Device 10

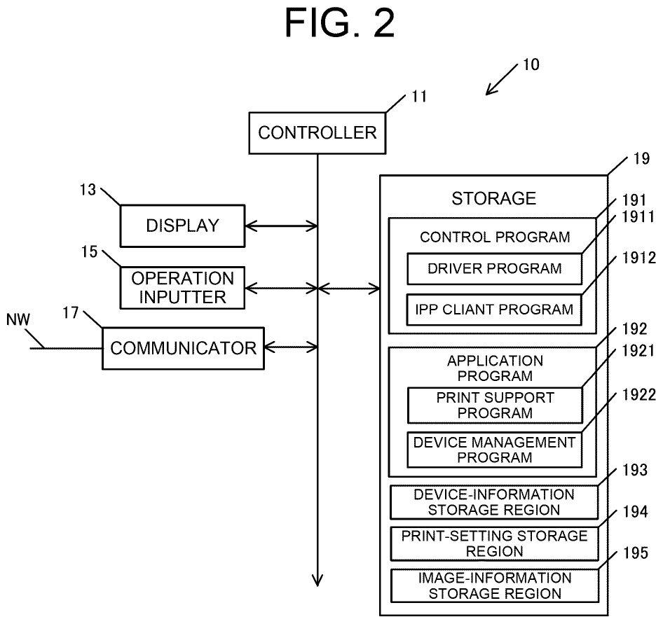

A functional configuration of the terminal device 10 will be explained. FIG. 2 is a diagram for explaining a functional configuration of the terminal device 10. The terminal device 10 includes a controller 11, a display 13, an operation inputter 15, a communicator 17, and a storage 19.

The controller 11 controls the entire terminal device 10. The controller 11 is configured by, for example, one or more arithmetic devices (such as Central Processing Units (CPU) and the like). The controller 11 realizes its functions by reading and executing various programs stored in the storage 19.

The display 13 is a display device that displays various kinds of information to a user or the like. The display 13 can be configured by, for example, a Liquid Crystal Display (LCD), an organic Electro-luminescence (EL) display or the like.

The operation inputter 15 is an input device that accepts an input of information from a user or the like. As the operation inputter 15, an inputter such as a keyboard, a mouse, a touch panel or the like can be used, for example.

The communicator 17 includes, for example, either one or both of a wired/wireless interface for performing communication with another apparatus (the multifunction peripheral 30 or the like) via a Local Area Network (LAN), a Wide Area Network (WAN), the Internet, a telephone line or the like. Note that, the communicator 17 may include an interface related to (short-range) wireless communication art such as Bluetooth (Registered Trademark), Near Field Communication (NFC), Wi-Fi (Registered Trademark), ZigBee (Registered Trademark), IrDA, wireless USB and the like, for example.

The storage 19 is a storage device that stores various programs required for the operation of the terminal device 10 and various types of data. The storage 19 can be constituted by storage devices such as a Random Access Memory (RAM), a Hard Disk Drive (HDD), a Solid State Drive (SSD), a Read Only Memory (ROM) and the like, for example.

In the First Embodiment, the storage 19 stores a control program 191 and an application program 192 and ensures a device-information storage region 193, a print-setting storage region 194, and a screen-information storage region 195.

The application program 192 is stored in the storage 19 which is a non-transitory computer-readable recording medium such as a ROM, for example.

The control program 191 is a program read by the controller 11 when the terminal device 10 is integrally controlled. The controller 11 that has read the control program 191 functions as an OS and performs control of driving of hardware such as the display 13, the operation inputter 15, the communicator 17 and the like, activation and termination of an application driven on the OS, file management and the like. Further, when a (new) connection with the multifunction peripheral 30 or the like is detected on the basis of a plug-and-play function or the like, the controller 11 that has read the control program 191 executes processing (acquisition of device information, for example) required for recognizing and using the multifunction peripheral 30 or the like. The controller 11 manages the obtained device information in Device Containers, which will be described later.

The control program 191 includes a driver program 1911 and an IPP client program 1912. The driver program 1911 is a standard printer driver that operates on the OS. The IPP client program 1912 is a program read by the controller 11 when a print job is exchanged with the multifunction peripheral 30 or the like on the basis of the IPP. The controller 11 that has read the IPP client program 1912 searches the multifunction peripheral 30 or the like and transmits an acquisition request for capability information or a generated print job to the multifunction peripheral 30 or the like on the basis of the IPP.

The application program 192 is a program read by the controller 11 upon receipt of an activation instruction from the user. The controller 11 that has read the application program 192 provides a specific function corresponding to the purpose of the user, such as document creation, graphic drawing, Internet browsing and the like. The application program 192 can be acquired by installation using a recording medium such as a CD or a DVD, downloading from a service providing server (not shown), or the like.

The application program 192 includes a print support program 1921 and a device management program 1922. The print support program 1921 is a program that functions as the PSA by being read by the controller 11 and improves and enhances a print result in cooperation with the printer driver. When the controller 11 is activated as the PSA, the controller 11 refers to the Device Containers managed by the OS to obtain information on devices such as the multifunction peripheral 30 as a printing apparatus associated with the PSA and the like. Here, the device information related to the present disclosure is a character string including at least a vendor identifier (vendor ID) for identifying a vendor of the PSA, the multifunction peripheral 30 or the like, and a device identifier (device ID) for identifying the multifunction peripheral 30 or the like as a printing apparatus. On the basis of the obtained device information, the controller 11 generates a setting screen (UI) for accepting print settings corresponding to the multifunction peripheral 30 or the like and displays it on the display 13. The controller 11 stores the print settings accepted via the setting screen in the storage 19. Then, when an input of a print execution instruction is accepted, the controller 11 generates a print job in which the stored print setting is reflected and transmits the print job to the target multifunction peripheral 30 or the like. The device management program 1922 is a program read by the controller 11 when the obtained device information is managed. The controller 11 that has read the device management program 1922 manages the device information of the multifunction peripheral 30 or the like associated with the PSA and information accompanying the device information by using a device management table, which will be described later.

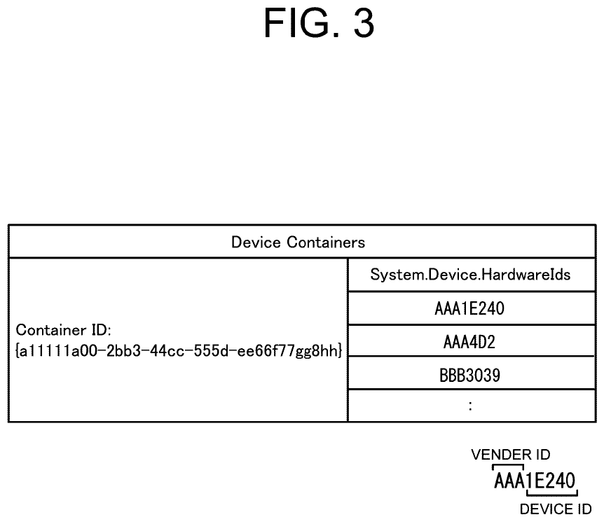

The device-information storage region 193 is a storage region that stores device information (Device Containers) obtained by the OS from the multifunction peripheral 30 or the like, and a device management table managed by the controller 11 that has read the device management program 1922. Here, an example of a data configuration of the Device Containers according to the present disclosure will be explained with reference to FIG. 3. The Device Containers is obtained by grouping, on a Container basis, pieces of device information required for recognizing and using devices (printing apparatuses) connected to the terminal devices 10.

The Device Containers identified by Container ID (a11111a00-2bb3-44cc-555d-ee66f77gg8hh) illustrated in FIG. 3 indicate that printing apparatuses (“AAA1E240” corresponding to the multifunction peripheral 30, “AAA4D2” corresponding to the multifunction peripheral 50, and “BBB3039” corresponding to another printing apparatus) as three types of devices belong to Device Containers.

Here, Syetem. Device. HardwareIds represents the vendor ID by the numerical values of the higher three digits and represents the device ID by the numerical values of the fourth and subsequent digits. For example, the vendor ID of AAA1E240 is “AAA”, and the device ID is “1E240”. Similarly, the vendor ID of BBB3039 is “BBB”, and the device ID is “3039”. For example, in a case where the PSA is an application provided by the vendor “AAA”, when the PSA is activated, the controller 11 obtains AAA1E240 and AAA4D2 to which the vendor ID “AAA” is assigned as the device (printing apparatus) associated with the PSA as the device information.

The print-setting storage region 194 is a storage region that stores print settings corresponding to the printing apparatus.

The screen-information storage region 195 is a storage region that stores screen information (image/screen contents) of a user interface (UI) screen such as a setting screen for accepting selection of the multifunction peripheral 30 or the like which causes print processing to be executed, a setting screen for accepting print settings corresponding to the multifunction peripheral 30 or the like.

### 1. 2. 2 Multifunction Peripheral 30 and the Like

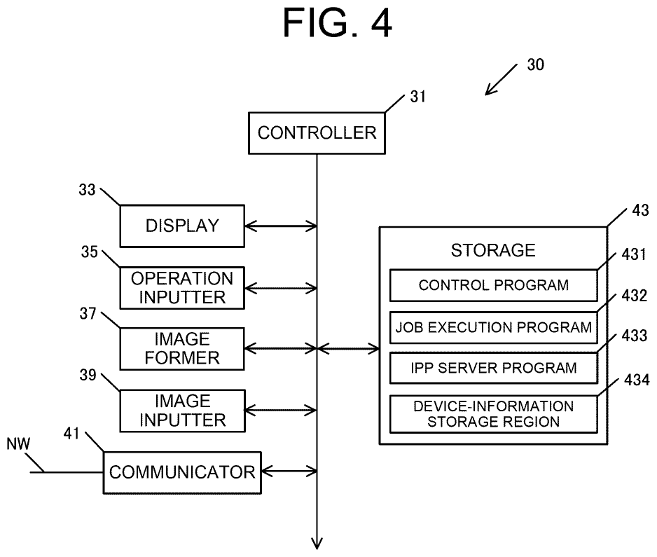

Subsequently a functional configuration of the multifunction peripheral 30 will be explained. FIG. 4 is a functional configuration diagram of the multifunction peripheral 30. The multifunction peripheral 30 includes a controller 31, a display 33, an operation inputter 35, an image former 37, an image inputter 39, a communicator 41, and a storage 43. Note that, the multifunction peripheral 50 is an apparatus different from the multifunction peripheral 30 and requires different print settings and thus, a functional configuration common to both the multifunction peripherals will be explained.

The controller 31 controls the entire multifunction peripheral 30. The controller 31 is constituted by one or more arithmetic devices (such as CPUs), for example. The controller 31 realizes its functions by reading and executing various programs stored in the storage 43.

The display 33 is a display device that displays various kinds of information to a user or the like. The display 33 may be constituted by an LCD, an organic EL display or the like, for example.

The operation inputter 35 is an input device that accepts input of information by a user or the like. The operation inputter 35 can be constituted by various input devices including operation keys such as hard keys and software key, buttons or the like, for example. Note that the operation inputter 35 may be configured as a touch panel that allows an input via the display 33. In this case, as an input method of the touch panel, a general method such as a resistive film method, an infrared method, an electromagnetic induction method, or a capacitance method, for example, can be adopted.

The image former 37 feeds a sheet from a feed tray, not shown, forms an image based on document data included in a print job and then, discharges the sheet to a sheet discharger, not shown. The image former 37 may be configured by a laser printer or the like employing an electrophotographic method, for example. In this case, the image former 37 forms images using toners supplied from toner cartridges, not shown, corresponding to respective toner colors (cyan, magenta, yellow, and black, for example).

The image inputter 39 generates document data by scanning a manuscript The image inputter 39 includes an image sensor such as a Charge Coupled device (CCD), a Contact Image Sensor (CIS) or the like, and can be configured as a scanner device having an Automatic document feeder (ADF), a flatbed on which the manuscript is placed and read, and the like. The configuration of the image inputter 39 is not particularly limited as long as it can generate image data by reading a reflected light image from a manuscript image with the image sensor. Note that the image inputter 39 can also be configured as an interface capable of obtaining the document data that is stored in a portable storage medium such as a Universal Serial Bus (USB) memory or the like and the print job transmitted from the terminal device 10, for example.

The communicator 41 includes, for example, either one or both of wired/wireless interfaces for performing communication with another device (the terminal device 10) via a network NW such as a LAN, a WAN, the Internet, a telephone line, or a fax line. Further, the communicator 41 may include an interface related to (short-range) wireless communication art such as Bluetooth (Registered Trademark), Near field communication (NFC), Wi-Fi (Registered Trademark), ZigBee (Registered Trademark), Irda, wireless USB and the like, for example.

The storage 43 stores various programs and various data required for the operation of the multifunction peripheral 30. The storage 43 may be constituted by a storage device such as a RAM, an HDD, an SSD, a ROM, and the like, for example.

In the First Embodiment, the storage 43 stores a control program 431, a job execution program 432, and an IPP server program 433 and ensures a device-information storage region 434.

The control program 431 is a program read by the controller 31 when the multifunction peripheral 30 is integrally controlled. The controller 31 that has read the control program 431 controls the driving of the display 33, the operation inputter 35, the image former 37, the image inputter 39, the communicator 41, and the like.

The job execution program 432 is a program read by the controller 31 when a job such as printing, copying, faxing, image transmission or the like is executed.

The IPP server program 433 is a program read by the controller 31 when a print job is exchanged with the terminal device 10 as a client device on the basis of the IPP. The controller 31 that has read the IPP server program 433 obtains a response to the search by the terminal device 10, a response to the acquisition request of the capability information, or a print job transmitted from the terminal device 10.

The device-information storage region 434 is a storage region that stores device information (device ID and device information) of the multifunction peripheral 30.

### 1. 3 Flow of Processing

### 1. 3. 1 Flow of Print Processing Using Printer Driver and the PSA

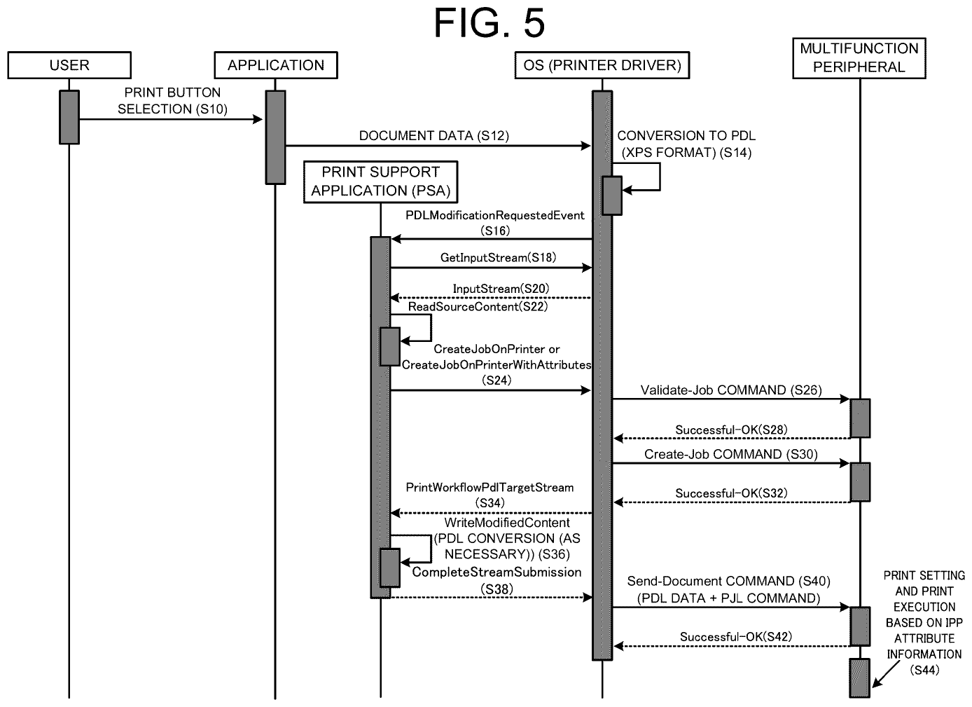

Before explaining the flow of processing according to the First Embodiment, print processing using a printer driver and the PSA will be explained. In FIG. 5, a mode in which the OS (printer driver) of the terminal device 10 outputs a print job to the multifunction peripheral 30 will be explained.

FIG. 5 is a sequence diagram illustrating a print processing using the printer driver and the PSA. First, the user selects a print button provided in a print dialog (not shown) of an application such as document creation, graphic drawing, Internet browsing and the like in order to print a document, a graphic, or a Web page created by the application (S10).

When selection of the print button is received, the application passes the document data corresponding to the created document, graphic or the like to the OS (printer driver) (S12).

The OS (printer driver) converts the document data to PDL data (XPS format, for example) (S14).

The OS (printer driver) converts the document data to PDL data (XPS format, for example) and then, executes PDLModificationRequestEvent of the PSA (S16).

The PSA requests the OS (printer driver) to obtain PDL data (XPS format) (S18).

The OS (printer driver) that has received the request to obtain the PDL data (XPS format) passes the PDL data (XPS format) to the PSA (S20).

The PSA reads the obtained PDL (XPS format) (S22) and requests the OS (printer driver) to generate a print job to be executed by the multifunction peripheral 30 or a print job to which the IPP attribute information is added (S24). At this time, the PSA may request the OS (printer driver) to generate a print job to which the IPP attribute information is added on the basis of a print setting corresponding to the multifunction peripheral 30, which will be described later.

The OS (printer driver) transmits a Validate-Job command for confirming validity of the job to the multifunction peripheral 30 (S26).

When the Validate-Job command is received, the multifunction peripheral 30 transmits a status command of Successful-OK to the OS (printer driver) in accordance with the validity of the job (S28).

Upon receipt of the Successful-OK status command, the OS (printer driver) transmits a Create-Job command instructing job creation to the multifunction peripheral 30 (S30).

When the Create-job command is received, the multifunction peripheral 30 transmits a status command of Successful-OK to the OS (printer driver) in accordance with the acceptance state of the job creation (S32).

Upon receipt of the Successful-OK status command from the multifunction peripheral 30, the OS (printer driver) passes a stream for print output to the PSA (S34).

The PSA that has obtained the stream for outputting the print job converts the PDL (XPS format) to a predetermined PDL such as a PDF format, a PCL6 format or the like, as necessary (S36).

The PSA inserts the PDL data (PDL data after conversion in the case of conversion to a predetermined PDL format) and the PJL command into stream for outputting the print obtained at S34, and notifies the OS (printer driver) of completion (S38).

The OS (printer driver) transmits the obtained PDL data and PJL command to the multifunction peripheral 30 by the Send-Document command (S40).

When the Send-Document command is received, the multifunction peripheral 30 transmits a Successful-OK status command indicating that the PDL data and the IPP attribute information have been accepted to the OS (printer driver) (S42). The multifunction peripheral 30 then executes the print setting based on the IPP attribute information and executes the print (Step S44).

### 1. 3. 2 Flow of Processing with Activation of PSA

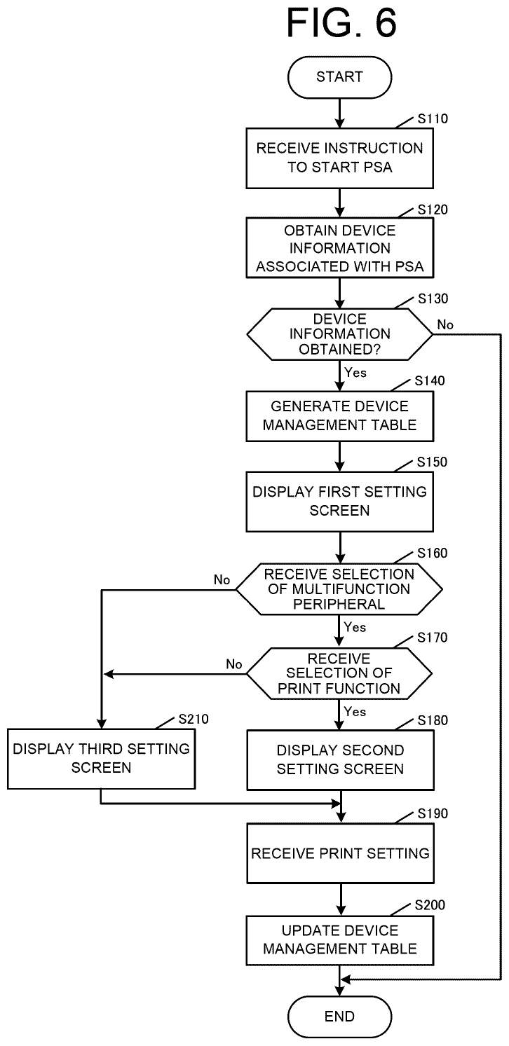

Subsequently, a flow of processing according to the First Embodiment will be explained with reference to a flowchart in FIG. 6. FIG. 6 is a flowchart illustrating processing executed by the controller 11 of the terminal device 10 when the PSA is activated as a flow of the processing according to the First Embodiment. The controller 11 of the terminal device 10 executes the processing illustrated in FIG. 6 by reading the print support program 1921, the device management program 1922, and the like.

The controller 11 accepts an input of an instruction to activate the PSA, when a PSA icon included in a start menu, not shown, is selected or when a printer driver is set up, for example (Step S110).

The controller 11 activates the PSA by reading the print support program 1921. With the activation of the PSA, the controller 11 refers to the System.Device.HardwareIDs of Device Containers illustrated in FIG. 3 to obtain the device information of the multifunction peripheral 30 or the like associated with the PSA (Step S120).

When the device information associated with the PSA could be obtained from Device Containers, the controller 11 generates a device management table (Step S130; Yes→Step S140). Note that the explanation here will be made by assuming that the PSA is an application provided by the vendor “AAA”, and “AAA1E240” corresponding to the multifunction peripheral 30 and “AAA4D2” corresponding to the multifunction peripheral 50 could be obtained as the device information of the multifunction peripherals associated with the PSA.

On the other hand, in a case where the device information associated with the PSA could not be obtained, the controller 11 ends the processing (Step S130; No→End).

Subsequently, the controller 11 displays, on the display 13, a first setting screen for accepting selection of the multifunction peripheral 30 or the like for which print settings are to be stored (managed) on the basis of the generated device management table (Step S150).

The controller 11 determines whether or not selection of either one of the multifunction peripherals 30 and 50 has been accepted via the first setting screen (Step S160). In a case where it is determined that either one of the multifunction peripheral 30 and the multifunction peripheral 50 was selected via the first setting screen, the controller 11 determines whether or not a print function which can be realized by the selected multifunction peripheral 30 or multifunction peripheral 50 was selected (Step S160; Yes→Step S170).

In a case where it is determined that the print function which can be realized by the selected multifunction peripheral 30 or the multifunction peripheral 50 was selected, the controller 11 displays the second setting screen related to the selected print function on the display 13 (Step S170: Yes→Step S180).

When the selection of the multifunction peripheral 30 or the multifunction peripheral 50 is not accepted through the first setting screen (Step S160; No), or when the selection of the print functions realizable by the selected multifunction peripheral 30 or the multifunction peripheral 50 is not accepted (Step S170; No), the controller 11 displays a third setting screen including the setting items (print functions) of all the multifunction peripherals (in this case, both the multifunction peripheral 30 and the multifunction peripheral 50) related to the device information obtained at Step S130 on the display 13 (Step S210).

The controller 11 accepts a print setting corresponding to the accepted print function via the second setting screen or the third setting screen (Step S190). The controller 11 updates the device management table generated at Step S140 on the basis of the print settings accepted at Step S190, and ends the processing (Step S200).

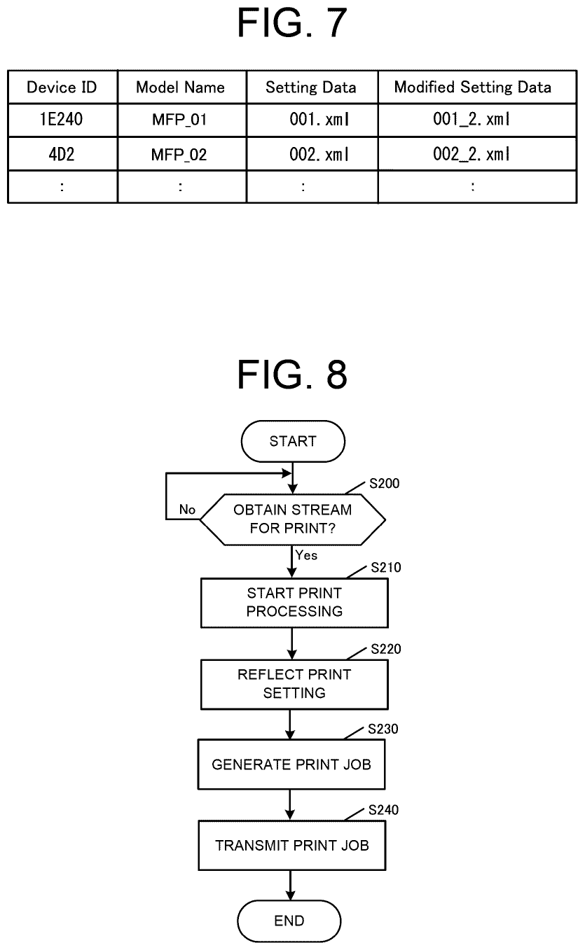

Here, the device management table generated by the controller 11 at Step S140 in FIG. 6 will be explained. FIG. 7 is a diagram for explaining an example of a data configuration of a device management table. Note that, the device management table may be in a table format as illustrated in FIG. 7 or may be a database.

The device management table includes Device ID, Model Name, Stting Data, and Modified Setting Data as management items. Note that, in FIG. 7, explanation will made by using the multifunction peripheral 30 (device information “AAA1E240”) and the multifunction peripheral 50 (device information “AAA4D2”) as the multifunction peripherals associated with the PSA (see FIG. 3).

The Device ID is a part corresponding to the device ID of the obtained device information. For example, Device ID “1E240” corresponds to the device ID “1E240” obtained from the device information “AAA1E240”. Model Name represents the model name “MFP 01” of the multifunction peripheral 30. Setting Data represents a print setting dataset “001.xml” containing default values of setting values to be applied on the print setting screen. Modified Setting Data represents a dataset “001_2.xml” containing a setting value (see Step S200 in FIG. 6) changed from the default value related to Setting Data.

Similarly, Device ID “4D2” corresponds to the device ID “4D2” obtained from the device information “AAA4D2”. Model Name represents the model name “MFP 02” of the multifunction peripheral 50. Setting Data represents a print setting dataset “002.xml” containing default values of setting values to be applied on the print setting screen. Modified Setting Data represents a dataset “002_2.xml” containing a setting value (see Step S200 in FIG. 6) changed from the default value related to Setting Data.

FIG. 8 is a flowchart for explaining processing for outputting a print job by using the device management table generated at Step S140 in FIG. 6. The processing explained in FIG. 8 is processing corresponding to a sequence from S20 to S40 described in FIG. 5.

The controller 11 determines whether or not a print stream has been obtained (Step S200). When it is determined that the printing stream has been obtained, the controller 11 starts the print processing (Step S210). Note that, when it is determined that the PDL data has not been obtained, the controller 11 waits until the PDL data is obtained (Step S200; No).

The controller 11 reads the Setting Data and the Modified Setting Data in the device management table and gives the setting value of the dataset as the IPP attribute information, thereby reflecting the print setting according to the multifunction peripheral 30 or the like (Step S220).

Subsequently, the controller 11 generates a print job to which the IPP attribute information was given (Step S230), transmits the generated print job to the multifunction peripheral 30 or the like selected at Step S160 in FIG. 6, and ends the processing (Step S240).

### 1. 4 Operation Example

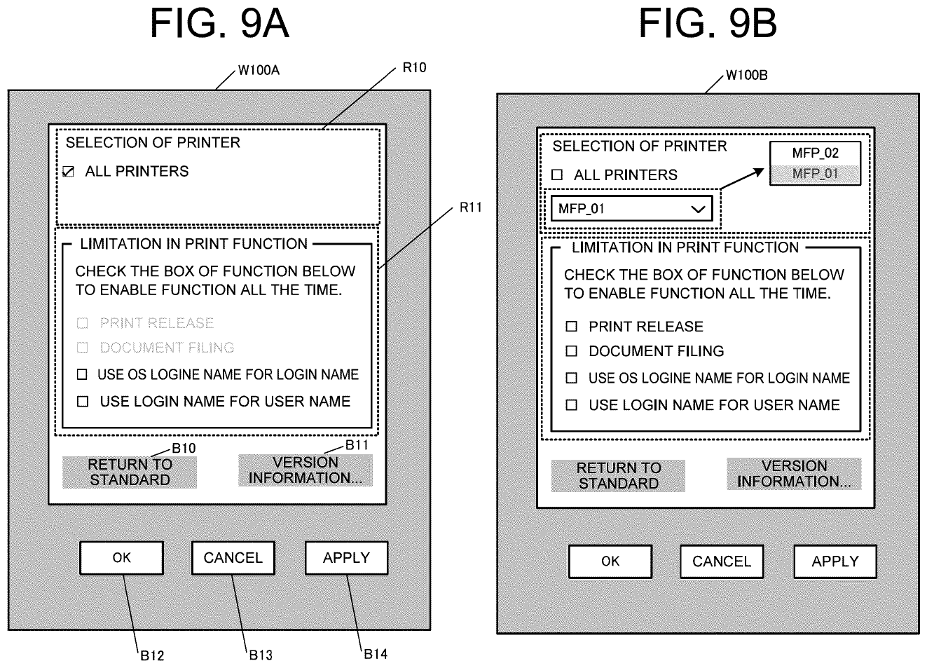

Subsequently, an operation example according to the First Embodiment will be explained. FIG. 9A and FIG. 9B are diagrams for explaining an activation screen W100 as a first setting screen displayed on the display 13 by the controller 11 when the PSA is activated. The activation screen W100 transitions to an activation screen W100A (FIG. 9A) or an activation screen W100B (FIG. 9B) in accordance with the selection regarding which of all the multifunction peripherals (the multifunction peripherals 30 and 50) associated with the PSA and one multifunction peripheral (the multifunction peripheral 30 or 50) associated with the PSA, the device for which print settings are to be stored (managed) should be.

Note that the activation screen W100A and the activation screen W100B can have the same screen configuration and thus, only the activation screen W100A will be explained here with reference numerals.

The activation screen W100A includes a printer selection region R10, a function limitation region R11, a “return to standard” button B10, a “version information” button B11, an “OK” button B12, a “cancel” button B13, and an “apply” button B14.

The printer selection region R10 is a region including a device selection item for accepting selection of a multifunction peripheral for which print settings are to be stored (managed). The printer selection region R10 includes an “all printers” check box. The “all printers” check box is a check box for accepting a selection in a case where all multifunction peripherals associated with the PSA are set as the multifunction peripherals for which print settings are to be stored (managed). When the “all printers” check box is checked and either the “OK” button B12 or the “apply” button B14 is selected after the selection of the required print functions in the function limitation region R11, the controller 11 confirms that the multifunction peripherals for which print settings are to be stored (managed) are all the multifunction peripherals associated with the PSA.

On the other hand, when the “all printers” check box is not checked, the controller 11 displays a pull-down menu for selecting one multifunction peripheral associated with the PSA as illustrated on the activation screen W100B. FIG. 9A and FIG. 9B are examples of a case where the device name “MFP-01” (the multifunction peripheral 30) or “MFP-02” (the multifunction peripheral 50) is selectably displayed as a selectable multifunction peripheral, and the device name “MFP-01” (the multifunction peripheral 30) was selected as a multifunction peripheral for which print settings are to be stored (managed).

The function limitation region R11 is a region including a function-selection item for accepting selection of enabling/disabling of print functions that can be realized by the selected multifunction peripheral (the multifunction peripheral 30 or the multifunction peripheral 50). The print functions selectably displayed in the function limitation region R11 may be appropriately changed in accordance with the selection result of the multifunction peripheral in the printer selection region R10. For example, when “all printers” is selected in the printer selection region R10, a print function that cannot be realized may be included in the multifunction peripherals selected as all printers. In such a case, as illustrated in FIG. 9A and FIG. 9B, it is also possible to perform display control such that unrealizable print functions are displayed in a grayed-out manner and cannot be selected as print functions to be enabled (for example, print release, document filing, and the like). Note that, in FIG. 9A and FIG. 9B, the four types of print functions, that is, “print release”, “document filing”, “use OS login name as login name”, and “use login name as user name” are exemplified as the print functions selectably displayed in the function limitation region R11, but the print functions that can be displayed in the function limitation region R11 are not limited thereto. For example, printing functions that can be realized by the printer driver alone, such as color/monochrome printing, double-sided/single-sided printing, and print finishing functions (stapling, punching, and the like) can be also included.

The “return to standard” button B10 is a button for accepting a selection to return the setting contents set in the printer selection region R10 and the function limitation region R11 to standard values (default values). The “version information” button B11 is a button for accepting an instruction to display the version information of the PSA.

The “OK” button B12 is a button for accepting a confirmation instruction of the setting contents set in the printer selection region R10 and the function limitation region R11. When the “OK” button B12 is selected, the controller 11 accepts the setting contents in the printer selection region R10 and the function limitation region R11 and ends the display of the activation screen W100A and the activation screen W100B. The “cancel” button B14 is a button for accepting an instruction to cancel the setting contents set in the printer selection region R10 and the function limitation region R11. The “apply” button B14 is a button for accepting a confirmation instruction of the setting contents set in the printer selection region R10 and the function limitation region R11. When the “apply” button B14 is selected, the controller 11 accepts the setting contents in the printer selection region R10 and the function limitation region R11, but the display of the activation screen W100A and the activation screen W100B is continued.

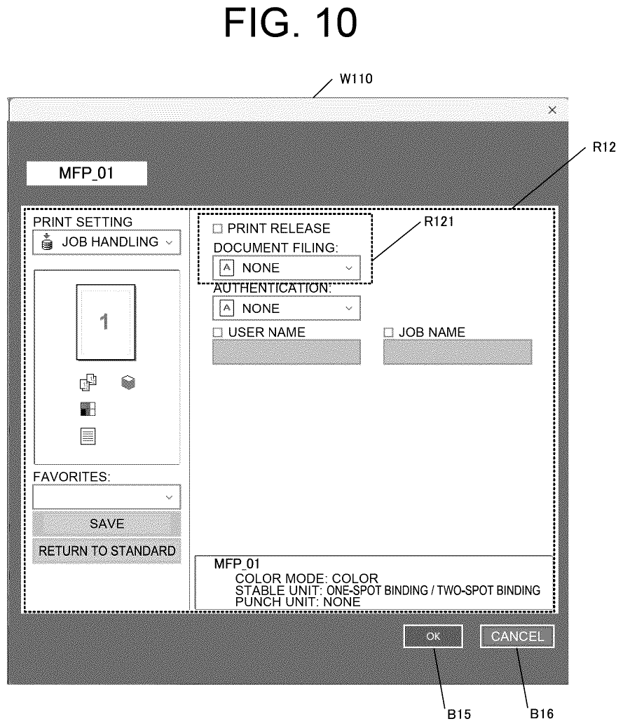

FIG. 10 is a diagram for explaining an example of a display configuration of the print setting screen W110 displayed as the third setting screen by the controller 11 when the device name “MFP-01” (multifunction peripheral 30) was selected as the multifunction peripheral for which print settings are to be stored (managed) in the printer selection region R10 on the activation screen W100B of FIG. 9A and FIG. 9B, but the specific print functions to be enabled were not selected in the function limitation region R11.

The print setting screen W110 includes a print setting region R12 in which all setting items related to the print functions of the device name “MFP-01” (multifunction peripheral 30) can be displayed. In FIG. 10, since the specific print functions were not selected in the function limitation region R11 on the activation screen W100B of 9B, all the setting items related to the print functions, that is, “print release”, “document filing”, “use OS login name as login name”, and “use login name as user name” are displayed Further, in the print setting region R12, a “save” button and a “return to standard” button are provided. The “save” button is a button for accepting a save instruction of the print setting corresponding to the print function set/changed in the print setting region R12. When the selection of the “save” button is accepted, the controller 11 stores the print setting corresponding to the print function accepted in the print setting region R12 as Modified Setting Data. Further, the “return to standard” button is a button for accepting an instruction to return the print setting corresponding to the print function which was set/changed in the print setting region R12 to a standard value (default value). When the selection of the “return to standard” button is accepted, the controller 11 returns the print setting corresponding to the print function accepted in the print setting region R12 to the standard value (default value), and stores the print setting as Setting Data.

The “OK” button B15 is a button for accepting a confirmation instruction of the setting contents in the print setting screen W110. The “cancel” button B16 is a button for accepting a cancellation instruction of the setting contents in the print setting screen W110.

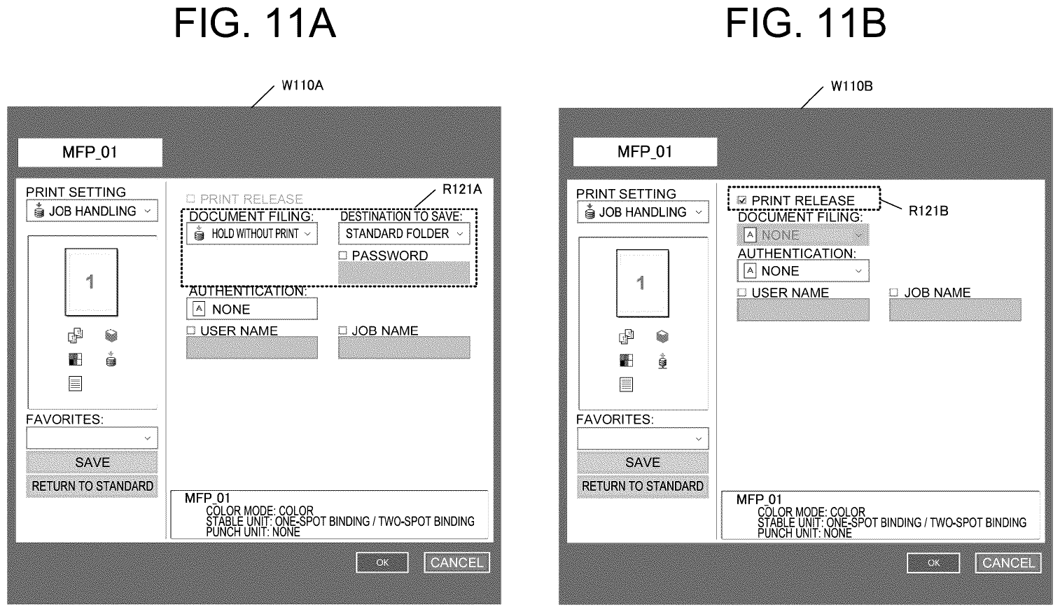

Here, among the setting items indicated in the print setting region R12, a mode of the print setting for the print functions related to “print release” and “document filing” (dotted-line frame R121 in the drawing) will be explained with reference to FIG. 11A and FIG. 11B.

FIG. 11A is diagrams for explaining an example of a display configuration of a print setting screen W110A for accepting print settings for the print function “document filing”. The print setting screen W110A can be displayed, for example, by selecting a desired function (hold without printing, for example) from the pull-down menu for accepting a function selection of “document filing” in the dotted-line frame R121 illustrated in FIG. 10.

The print setting screen W110A includes a print setting region R121A for accepting print settings related to the print function “document filing”. The print setting region R121A includes a pull-down menu for accepting a function selection of “document filing” as a print setting, a storage destination selection pull-down menu for accepting a selection of a storage destination of the image data, a password input box, and the like. The user can make necessary print settings regarding “document filing” via the print setting region R121A.

FIG. 11B is a diagram for explaining an example of a display configuration of a print setting screen W110B for accepting print settings for the print function “print release”. The print setting screen W110B can be displayed, for example, by checking a “print release” check box in the dotted-line frame R121 illustrated in FIG. 10.

The print setting screen W110B includes a print setting region R121B for accepting print settings related to the print function “print release”. Note that, in the print setting region R121B, only a “print release” check box for accepting an input of an instruction to enable “print release” is shown as a print setting, but it is needless to say that designator (such as a pull-down menu for accepting a selection of a master unit/a slave unit, an input box for accepting an input of a domain name, an address, or the like on the network NW, for example) for designating a master unit for storing image data (print data) or a slave unit for taking out the image data (print data) stored in the master unit and executing print processing can also be shown as necessary.

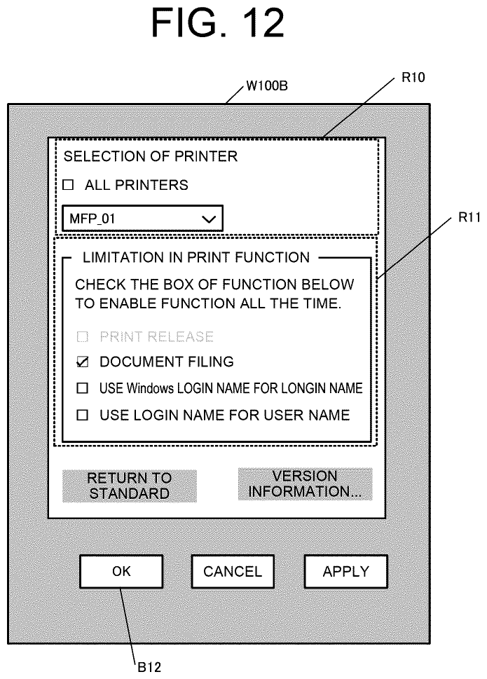

FIG. 12 is a diagram for explaining a state in which the device name “MFP-01” (multifunction peripheral 30) was selected as a multifunction peripheral for which print settings are to be stored (managed) in the printer selection region R10 of the activation screen W100B of FIG. 9B, and “document filing” was selected as a specific print function to be enabled in the function limitation region R11.

In the function limitation region R11, when the “OK” button B12 is selected after the “document filing” was selected as the specific printing function to be enabled, the controller 11 displays the print setting screen W120A in which the setting item related to the selected print function “document filing” is omitted as the second setting screen.

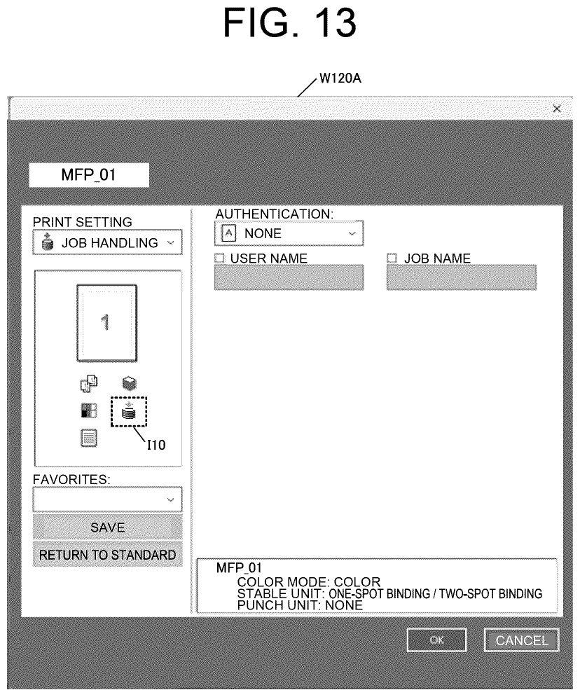

FIG. 13 is an example of a display configuration of the print setting screen W120A. On the print setting screen W120A, the print setting related to the print function “document filing” is omitted, but an icon I10 indicating that the print function is enabled is displayed. The user can grasp that the print function “document filing” is set to be enabled by confirming the figure represented by the icon I10.

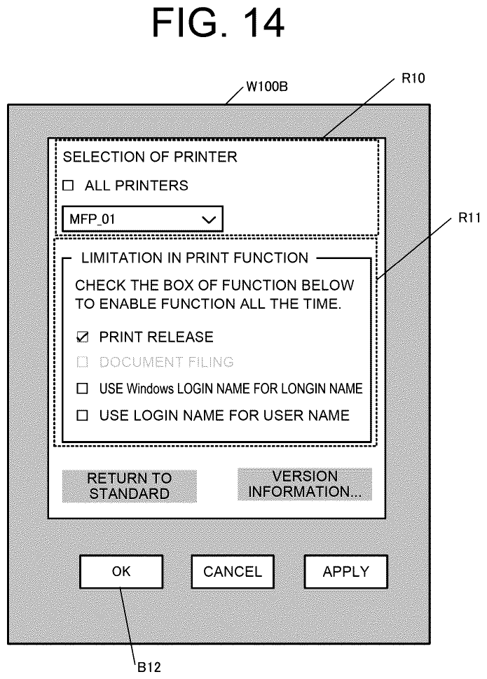

FIG. 14 is a diagram for explaining a state in which the device name “MFP-01” (multifunction peripheral 30) is selected as a multifunction peripheral for which print settings are to be stored (managed) in the printer selection region R10 of the activation screen W100B of FIG. 9B, and “print release” is selected as a specific print function to be enabled in the function limitation region R11.

When the “OK” button B12 is selected after the “print release” was selected as the specific print function to be enabled in the function limitation region R11, the controller 11 displays the print setting screen W120B in which the setting item related to the selected print function “print release” is omitted as the second setting screen.

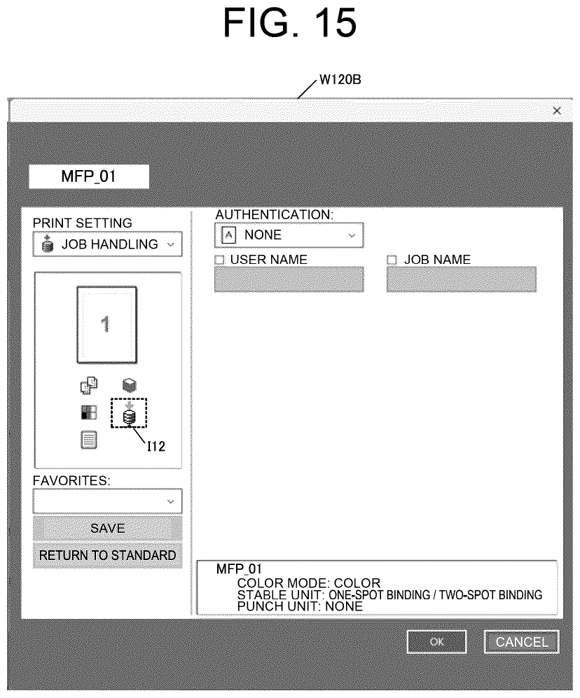

FIG. 15 is an example of a display configuration of the print setting screen W120B. On the print setting screen W120B, the print setting related to the print function “print release” is omitted, but an icon I12 indicating that the print function is enabled is displayed. The user can recognize that the print function “print release” is enabled by confirming the figure represented by the icon I12.

As described above, according to the First Embodiment, when the PSA is activated, the device information of the printing apparatus (multifunction peripheral) associated with the PSA can be obtained and the print settings corresponding to the printing apparatus can be stored in the storage on the basis of the obtained device information and thus, the print settings corresponding to the individual or all the printing apparatuses associated with the PSA can be applied to the print processing. In addition, according to the First Embodiment, since it is possible to generate and display the print setting screen (user interface screen) suitable for the selected printing apparatus according to the selection of the printing apparatus for which print settings are to be stored (managed), it is possible to reduce a burden of the user related to the print settings.

### 2 Second Embodiment

The Second Embodiment is a mode in which an authenticator is further provided in the configuration of the First Embodiment, and it is determined whether or not to accept selection of a printing apparatus (multifunction peripheral) for which print settings are to be stored (managed) in accordance with an authentication result by the authenticator.

### 2. 1 Overall Configuration

The overall configuration according to the Second Embodiment can be the same as the overall configuration according to the First Embodiment and thus, the explanation here will be omitted.

### 2. 2 Functional Configuration

### 2. 2. 1 Terminal Device 70

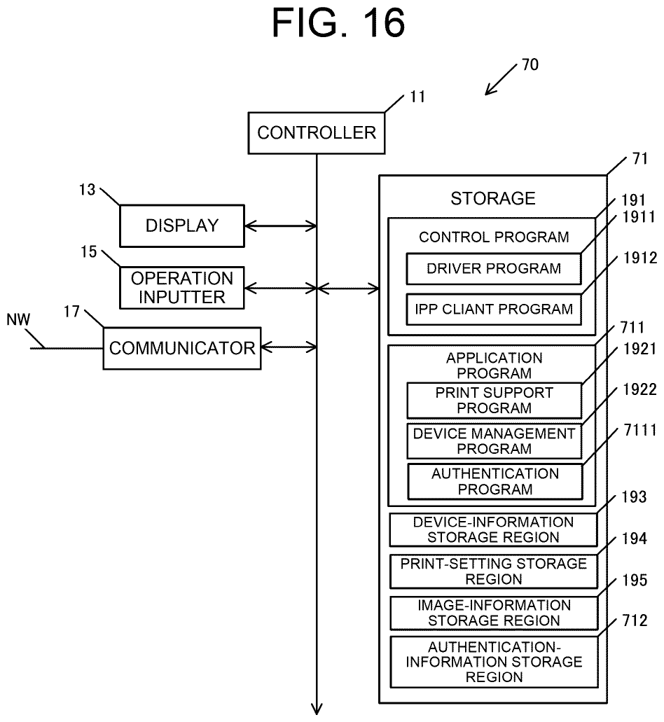

A functional configuration of a terminal device 70 according to the Second Embodiment will be explained with reference to FIG. 16. Note that, the same components as those of the terminal device 10 explained in FIG. 2 of the First Embodiment are given the same reference numerals, and the explanation thereof will be omitted.

The terminal device 70 includes the controller 11, the display 13, the operation inputter 15, the communicator 17, and a storage 71.

In the Second Embodiment, the storage 71 stores the control program 191 and an application program 711, and ensures the device-information storage region 193, the print-setting storage region 194, the screen-information storage region 195, and an authentication-information storage region 712.

The application program 711 includes an authentication program 7111 in addition to the print support program 1921 and the device management program 1922. The authentication program 7111 is a program that is read by the controller 11 when it is determined whether a login user of the terminal device 70 is a user having administrator authority or not. The controller 11 that has read the authentication program 7111 functions as an authenticator, and when a user authentication function is enabled, the controller 11 displays the login screen, not shown, on the display 13, and accepts an input of a login user name and a login password. The controller 11 may store login user names and login passwords related to the user authentication in association in advance so that the login authentication can be performed for the user by collating the login user name and the login password entered through the login screen. At this time, the controller 11 confirms the authority given to the login user and determines whether or not the login user is an administrator user having administrator authority. Note that, in addition to knowledge-based authentication based on an input of a login user name and a login password, the login authentication can be made by belonging authentication using, for example, a token, a key, an Integrated Circuit (IC) card, a smart-phone or the like or biometric authentication such as facial recognition or fingerprint recognition. Note that the controller 11 can determine whether the user authentication function is enabled/disabled on the basis of the setting contents set via the setting screen, not shown.

The authentication-information storage region 712 is a storage region that stores information related to authentication information such as a login user name, a login password, a type of authority given to the login user and the like, which are related to user authentication.

### 2. 2. 2 Multifunction Peripheral 30 and the Like

The functional configuration of a multifunction peripheral according to the Second Embodiment can be made the same as that of the multifunction peripheral 30 and the like according to the First Embodiment and thus, explanation here will be omitted.

### 2. 3 Flow of Processing

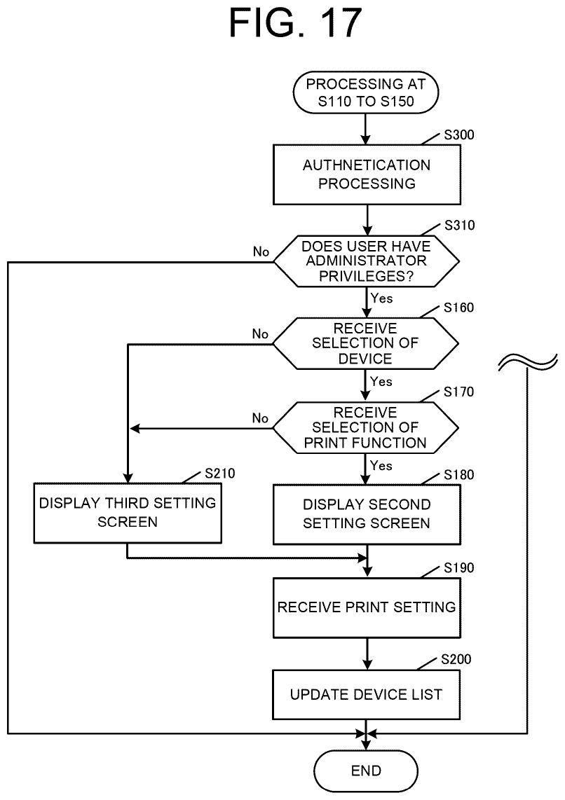

The flow of processing with the activation of the PSA according to the Second Embodiment can be explained as processing in which FIG. 6 of the First Embodiment is replaced with FIG. 17. Therefore, the same processing is given the same step number, and explanation thereof will be omitted.

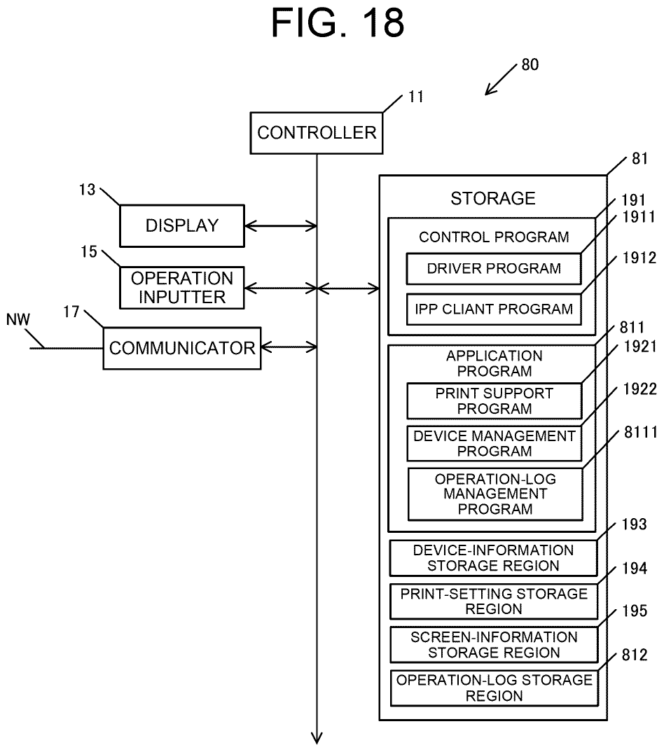

At Step S150 of FIG. 18, the controller 11 displays the first setting screen on the display 13 and then, starts authentication processing by reading the authentication program 7111 (Step S300).

As the result of the authentication processing, in a case where the controller 11 determines that the login user has the administrator authority, the controller 11 executes the processing at Step S160 and after (Step S310; Yes→Step S160). On the other hand, in a case where it is determined that the login user does not have the administrator authority, the controller 11 ends the processing (Step S310; No→End).

As described above, according to the Second Embodiment, in addition to the effects of the First Embodiment, since it is configured to determine whether the selection of a printing apparatus for which print settings are to be stored (managed) is to be accepted or not in accordance with the authentication result by the authenticator, it is possible to prevent a change of print settings by a user without administrator authority and thus, security of print processing can be further improved.

### 3 Third Embodiment

The third embodiment is a form in which an operation manager is further provided in the configuration of the First Embodiment, and it is determined whether or not to accept selection of a printing apparatus (multifunction peripheral) for which print settings are to be stored (managed in accordance with whether or not the user is a user who has installed the print support program 1921.

### 3. 1 Overall Configuration

The overall configuration according to the Third Embodiment can be the same as the overall configuration according to the First Embodiment and thus, the explanation here will be omitted.

### 3. 2 Functional Configuration

### 3. 2. 1 Terminal Device 80

A functional configuration of a terminal device 80 according to the Third Embodiment will be explained by using FIG. 18. Note that, the same components as those of the terminal device 10 explained in FIG. 2 of the First Embodiment are given the same reference numerals, and the explanation thereof will be omitted.

The terminal device 80 includes the controller 11, the display 13, the operation inputter 15, the communicator 17, and the storage 81.

In the Third Embodiment, the storage 81 stores the control program 191 and an application program 811 and ensures the device-information storage region 193, the print-setting storage region 194, the screen-information storage region 195, and an operation-log storage region 812.

The application program 811 includes an operation-log management program 8111 in addition to the print support program 1921 and the device management program 1922. The operation-log management program 8111 is a program read by the controller 11 when an operation performed on the terminal device 80 is managed as an operation log. The controller 11 that has read the operation-log management program 8111 can manage, for example, installation/uninstallation of an application performed on the terminal device 80 as an operation log. The operation log can include application information such as vendor information for identifying an application, a product ID, and a user ID in addition to operation management information such as time and date when installation/uninstallation was performed and an executor (administrator user) of installation/uninstallation.

The operation-log storage region 812 is a storage region for storing information related to the operation log.

### 3. 2. 2 Multifunction Peripheral 30 and the Like

The functional configuration of a multifunction peripheral according to the Third Embodiment can be made the same as that of the multifunction peripheral 30 and the like according to the First Embodiment and thus, explanation here will be omitted.

### 3. 3 Flow of Processing

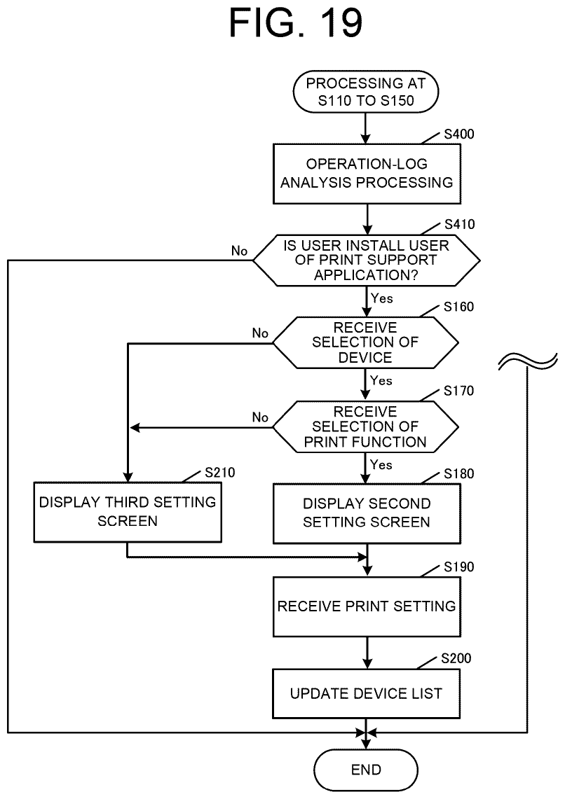

The flow of processing with the activation of the PSA according to the Third Embodiment can be explained as processing in which FIG. 6 of the First Embodiment is replaced with FIG. 19. Therefore, the same processing is given the same step number, and explanation thereof will be omitted.

At Step S150 of FIG. 19, the controller 11 displays the first setting screen on the display 13 and then, starts analysis processing of the operation log by reading the operation-log management program 8111 (Step S400).

As the result of the analysis of the operation log, in a case where the controller 11 determines that the user who operates the terminal device 80 is an installation user who installed the print support program 1921, the controller 11 executes the processing at Step S160 and after (Step S410; Yes→Step S160). On the other hand, in a case where it is determined that the user who operates the terminal device 80 is not the installation user who installed the print support program 1921, the controller 11 ends the processing (Step S410; No→End).

As described above, according to the Third Embodiment, in addition to the effects of the First Embodiment, it is configured to determine whether or not to accept selection of a printing apparatus (multifunction peripheral) for which print settings are to be stored (managed) in accordance with whether the user who operates the terminal device is a user who installed the print support program 1921 or not and thus, it is possible to prevent a change of the print settings by a user who is not the installation user of the PSA and similarly to the Second Embodiment, security related to the print processing can be further improved.

The present disclosure is not limited to the above-described Embodiments, and various modifications can be made. That is, the technical scope of the present disclosure also includes such embodiments that can be obtained by combining technical measures that are modified as appropriate within a range not departing from the gist of the present disclosure.

Further, although some parts of the above-described Embodiments were explained separately for convenience, it is a matter of course that the Embodiments may be executed in combination within a technically capable range.

Further, a program that operates on each apparatus in the Embodiments is a program that controls a CPU or the like (a program that causes a computer to function) so as to realize the functions of the above-described Embodiments. And the information handled in these apparatuses is temporarily accumulated in a temporary storage device (for example, the RAM) during processing and then, stored in various storage devices such as the ROM, HDD and the like, and is read, corrected, or written by the CPU as necessary.

Here, the computer-readable non-transitory recording medium in which the program is recorded in the information processing apparatus may be any of semiconductor media (for example, a ROM, a nonvolatile memory card, or the like), an optical recording medium/magneto-optical recording medium (for example, a Digital Versatile Disc (DVD), a Magneto Optical Disc (MO), a Mini Disc (MD), a Compact Disc (CD), a Blu-ray (Registered Trademark) disc (BD), or the like), a magnetic recording medium (for example, a magnetic tape, a flexible disk, or the like), or the like. In this case, the program recorded in the recording medium is read by the computer of the information processing apparatus and executed by the computer, whereby not only that the functions of the above-described Embodiments are realized, but also that the functions of the present disclosure are realized by executing processing in cooperation with an operating system, another application program, or the like on the basis of instructions of the program.

Further, in a case where the program is distributed in the market, the program can be stored in a portable recording medium and distributed, or can be transferred to a server computer connected via a network such as the Internet. In this case, a storage device of the server computer is also included in the present disclosure as a matter of course.

Further, each functional block or various features of the devices used in the above-described Embodiments can be implemented or executed by an electric circuit, for example, an integrated circuit or a plurality of integrated circuits. The electrical circuit that is designed to realize the functions described in the present specification may include a general-purpose processor, a digital signal processor (DSP), an application-specific integrated circuit (ASIC), a field programmable gate array (FPGA), other programmable logic devices, a discrete gate or transistor logic, a discrete hardware component, or a combination of them. The general-purpose processor may be a microprocessor or may be a conventional processor, a controller, a micro controller, or a state machine. The above-described electrical circuit may be configured as a digital circuit or may be configured as an analog circuit. Further, when an integrated circuit technology that replaces the current integrated circuits emerges as the result of progress of the semiconductor technology, one or more aspects of the present disclosure may also use new integrated circuits based on such technology.

What is claimed is:

1. An information processing apparatus comprising: a storage that stores an application capable of supporting print settings corresponding to a device in cooperation with a printer driver; and
a controller that obtains device information of the device associated with the application when the application is activated, wherein
the controller stores the print setting corresponding to the device in the storage on the basis of the obtained device information; and
reflects the print settings stored in the storage, when executing print on the basis of the application.

2. The information processing apparatus according to claim 1, wherein the controller displays
a first setting screen that accepts selection of the device for which the print settings are to be stored, on the display.

3. The information processing apparatus according to claim 2, wherein the first setting screen includes
a device selection item that accepts selection of all the devices or one of all the devices related to the obtained device information.

4. The information processing apparatus according to claim 3, wherein the first setting screen includes
a function selection item that accepts selection of a print function realizable by the selected device.

5. The information processing apparatus according to claim 4, wherein the controller displays
a second setting screen with the selected print function omitted on the display, when the selection of the specific print function is accepted via the function selection item.

6. The information processing apparatus according to claim 5, wherein the second setting screen includes
an icon representing the selected print function.

7. The information processing apparatus according to claim 4, wherein the controller displays
a third setting screen including all the setting items related to the print function on the display, when the selection of the specific print function is not accepted on the first setting screen.

8. The information processing apparatus according to claim 2, further comprising an authenticator that authenticates a user, wherein the controller determines
whether or not to accept selection of the device for which the print settings are to be stored on the basis of an authentication result of the user by the authenticator.

9. The information processing apparatus according to claim 2, wherein the controller determines
whether or not to accept selection of the device for which the print settings are to be stored on the basis of whether a user is the user who installed the application or not.

10. A print setting method, comprising steps for:
storing, in cooperation with a printer driver, an application capable of supporting print settings corresponding to a device, in a storage;
obtaining device information of the device associated with the application, when the application is activated;
storing the print settings corresponding to the device, in the storage device, on the basis of the obtained device information; and
reflecting the print settings stored in the storage, when executing print on the basis of the application.

11. A non-transitory computer-readable recording medium having an application recorded thereon, wherein
the application is capable of supporting print settings corresponding to a device in cooperation with a printer driver and obtains device information of the associated devices at the time of activation;
stores the print settings corresponding to the device in a storage device on the basis of the obtained device information; and
reflects the print settings stored in the storage, when a print execution instruction is accepted.
